(19) United States
(12) Patent Application Publication
(10) Pub. No.: US 2025/0230904 A1
(43) Pub. Date: Jul. 17, 2025

(54) APPARATUSES AND METHODS OF PUMPING SENSITIVE FLUIDS

(71) Applicant: ChampionX LLC, Sugar Land, TX (US)

(72) Inventors: Kerry Charles Brinkman, Sugar Land, TX (US); Tri T. Phan, Sugar Land, TX (US); Michael Cash, Richmond, TX (US)

(21) Appl. No.: 19/017,961

(22) Filed: Jan. 13, 2025

Related U.S. Application Data
(60) Provisional application No. 63/620,259, filed on Jan. 12, 2024.

(51) Int. Cl. F17D 1/17; E21B 43/16

(52) U.S. Cl. CPC F17D 1/17; E21B 43/16

(57) ABSTRACT

Apparatuses and methods for pumping emulsion polymers and other sensitive fluids that eliminates the high shear that can be destructive to the fluid have been developed. These methods can be used to deliver emulsion polymers continuously from topside through umbilical to subsea produced fluids flowlines to increase oil production and/or flow of gas/oil by reducing friction loss due to turbulent flow in the flowlines.

### FIELD OF THE INVENTION

The present disclosure relates to apparatuses and methods for pumping emulsion polymers and other sensitive fluids that reduces the high shear that can be disadvantageous to the fluid. These methods can be used to deliver emulsion polymers continuously from topside through umbilical to subsea produced fluid flowlines to increase oil production and/or flow of gas/oil by reducing friction loss due to turbulent flow in the flowlines.

### BACKGROUND OF THE INVENTION

The challenge of agglomeration and deposit formation when pumping emulsion polymers is significant for oil and gas production systems. Several methods and compositions have been proposed to address this challenge. For example, compositions that incorporated plasticizers into the solid polymer particles helped to reduce deposits in pumps; additives of diesters and triesters of diols and polyols used to improve drag reducer injection and reduce deposit formation; and barrier materials applied to surfaces in diaphragm pumps can be used.

There are very few pump designs that can produce pressures of 10,000 psi or greater that is needed to push an emulsion polymer through an umbilical tube and into a pressurized manifold in the seafloor. Pneumatic plunger pumps are most commonly used on offshore platforms to pump additives down an umbilical. With drag-reducing agent (DRA) emulsions, polymer particle aggregation occurs at the intersection of the plunger and the elastomer seal to form deposits that create major operability problems. The elastomer may be acting as a catalytic surface to facilitate binding of the sticky particles. A surface coating for a diaphragm pump is not practical in a plunger pump.

Thus, additional techniques are needed to address pump deposit formation as known methods are inadequate to combat pump deposit formation with an emulsion that is formulated to meet all of the challenges inherent in applying a subsea DRA.

### BRIEF SUMMARY OF THE INVENTION

Various apparatuses and methods are disclosed herein.

As the pressure in the pump increases, more deposits are created between the pump's high pressure seals and the pump's piston seal. During compression of the fluid, when the seal that is moving against the wall is increasing the pressure, the intersection between the seal surface and the pump wall is where agglomeration of an emulsion can be formed. The pump apparatus described herein has a configuration that can reduce the agglomeration of an emulsion and reduce the amount of deposits and fouling occurring in the pump apparatus.

One aspect of the disclosure is directed to an apparatus for pumping a shear-sensitive fluid to an application, as depicted in FIG. 1, the apparatus comprising: a first reservoir for holding a first fluid; a second reservoir for holding a second fluid wherein the second fluid is a shear-sensitive fluid; a first vessel comprising a first chamber and a second chamber, a movable partition between the first chamber and the second chamber wherein the first chamber and the second chamber are not in fluid communication with each other; a high pressure pump in fluid communication with the first reservoir and the first chamber through the first fill line and a first chamber inlet valve; a low pressure pump in fluid communication with the second reservoir and the second chamber through a second fill line and a second chamber inlet valve; a first recycle line in fluid communication with the first chamber and the first fluid reservoir through the first chamber outlet valve; and a second exit line in fluid communication with the second chamber and a process line through the second chamber outlet valve; and a switching circuit in electrical communication with any actuators associated with the first chamber inlet valve, the first chamber outlet valve, the second chamber inlet valve, and the second chamber outlet valve.

Another aspect of the disclosure is an apparatus for pumping a shear-sensitive fluid to an application, as depicted in FIG. 2, the apparatus comprising: a first reservoir for holding a first fluid; a second reservoir for holding a second fluid wherein the second fluid is a shear-sensitive fluid; a first vessel comprising a first chamber and a second chamber, a movable partition between the first chamber and the second chamber wherein the first chamber and the second chamber are not in fluid communication with each other; a second vessel comprising a third chamber and a fourth chamber, a movable partition between the third chamber and the fourth chamber wherein the third chamber and the fourth chamber are not in fluid communication with each other; a high pressure pump in fluid communication with the first reservoir, the first chamber, and the third chamber through a first fill line, a first chamber inlet valve, and a third chamber inlet valve; a low pressure pump in fluid communication with the second reservoir, the second chamber, and the fourth chamber through a second fill line, a second chamber inlet valve, and a fourth chamber inlet valve; a first recycle line in fluid communication with the first chamber and the first fluid reservoir through the first chamber outlet valve; a second recycle line in fluid communication with the third chamber and the first fluid reservoir through the third chamber outlet valve; a second exit line in fluid communication with the second chamber and an umbilical line through the second chamber outlet valve; a fourth exit line in fluid communication with the fourth chamber and the umbilical line through the fourth chamber outlet valve; and a switching circuit in electrical communication with any actuators associated with the high pressure pump, the low pressure pump, the first chamber inlet valve, the first chamber outlet valve, the second chamber inlet valve, the second chamber outlet valve, the third chamber inlet valve, the third chamber outlet valve, the fourth chamber inlet valve, and the fourth chamber outlet valve.

In another aspect, the disclosure is directed to a method of pumping a shear-sensitive fluid to an application using the two-chambered apparatus described elsewhere in this disclosure and in FIG. 1, the method comprising: filling the first reservoir with the first fluid; filling the second reservoir with the second shear-sensitive fluid; pumping the second fluid from the second reservoir through the second fill line into the second chamber using the low pressure pump while having the first chamber outlet valve open and allowing the first fluid through the first recycle line to the first reservoir; then closing the first chamber outlet valve based on a sensor value, based upon the flowrate of the low pressure pump, such that the fluid level in the first chamber is less than 10% of the total volume of the first vessel and pumping the first fluid from the first reservoir through the first fill line into the first chamber using the high pressure pump while having the second chamber outlet valve open allowing the shear-sensitive fluid to flow into the process line; opening the first chamber outlet valve based on a sensor value, based upon the flowrate of the high pressure pump, such that the fluid level in the first chamber is greater than 50% of the total volume of the first vessel, and allowing the process to repeat.

In yet another aspect, the disclosure is directed to a method of pumping a shear-sensitive fluid to an application using the four-chambered apparatus described elsewhere in this disclosure and in FIG. 2, the method comprising: filling the first reservoir with the first fluid; filling the second reservoir with the second shear-sensitive fluid; pumping the second fluid from the second reservoir through the second fill line into the second chamber using the low pressure pump while having the first chamber outlet valve open and allowing the first fluid through the first recycle line to the first reservoir; pumping the first fluid from the first reservoir through the first fill line into the third chamber through the third chamber inlet valve using the high pressure pump while having the fourth chamber outlet valve open allowing the shear-sensitive fluid to flow into the process line; then closing the first chamber outlet valve and opening the third chamber outlet valve based on a sensor value, based upon the flowrate of the low pressure pump, such that the fluid level in the first chamber is less than 10% of the total volume of the first vessel and pumping the first fluid from the first reservoir through the first fill line into the first chamber through the first chamber inlet valve using the high pressure pump while having the second chamber outlet valve open allowing the shear-sensitive fluid to flow into the process line; pumping the second fluid from the second reservoir through the second fill line (the second chamber inlet valve is closed) into the fourth chamber through the fourth chamber inlet valve using the low pressure pump while having the third chamber outlet valve open and allowing the first fluid to flow through the second recycle line to the first reservoir; then opening the first chamber inlet valve and closing the third chamber inlet based on a sensor value, based upon the flowrate of the low pressure pump, such that the fluid level in the third chamber is less than 10% of the total volume of the second vessel and allowing the process to repeat.

Another aspect of the disclosure is a method of increasing oil production and/or flow of oil by reducing friction loss due to turbulent flow in subsea produced fluid flowlines, the method comprising: performing one of the methods described elsewhere in the disclosure; wherein the first fluid comprises a drag reducing agent (DRA) and the process line is an umbilical line; wherein the drag reducing agent is continuously delivered from topside through umbilical to the flowlines.

Other objects and features will be in part apparent and in part pointed out hereinafter.

### BRIEF DESCRIPTION OF THE SEVERAL VIEWS OF THE DRAWING

FIG. 1 depicts an apparatus for pumping a shear-sensitive fluid to an application.

FIG. 2 depicts an apparatus for continuous pumping of a shear-sensitive fluid to an application.

Corresponding reference characters indicate corresponding parts throughout the drawings.

### DETAILED DESCRIPTION OF THE INVENTION

The very high pressures required for pumping a drag reducing agent into a subsea manifold precluded the use of most standard pumps and equipment. It was not discovered until recently that accumulators were available commercially that could handle this pressure. Accumulators are designed for pressurizing hydraulic fluid using high-pressure air to fill the bladder (or upper section in a piston or diaphragm accumulator).

The systems described herein contemplate use of two bladder accumulators to facilitate pumping the emulsion polymer without pumping it directly through a high-shear, high-pressure pump. The high-pressure pump would pump a stable, non-compressible fluid like water into the bladder in the accumulator. The expanding bladder would force the emulsion polymer out of the accumulator and down the umbilical tube to the seafloor. While this is happening, the second accumulator would be refilling with emulsion polymer using a low-shear pump. The water in the bladder would be vented back to a reservoir at ambient pressure. A switching mechanism or circuit, for example, a programmable logic controller (PLC) would switch back and forth between the two accumulators by actuating inlet and outlet valves to keep a constant flow of emulsion to the application.

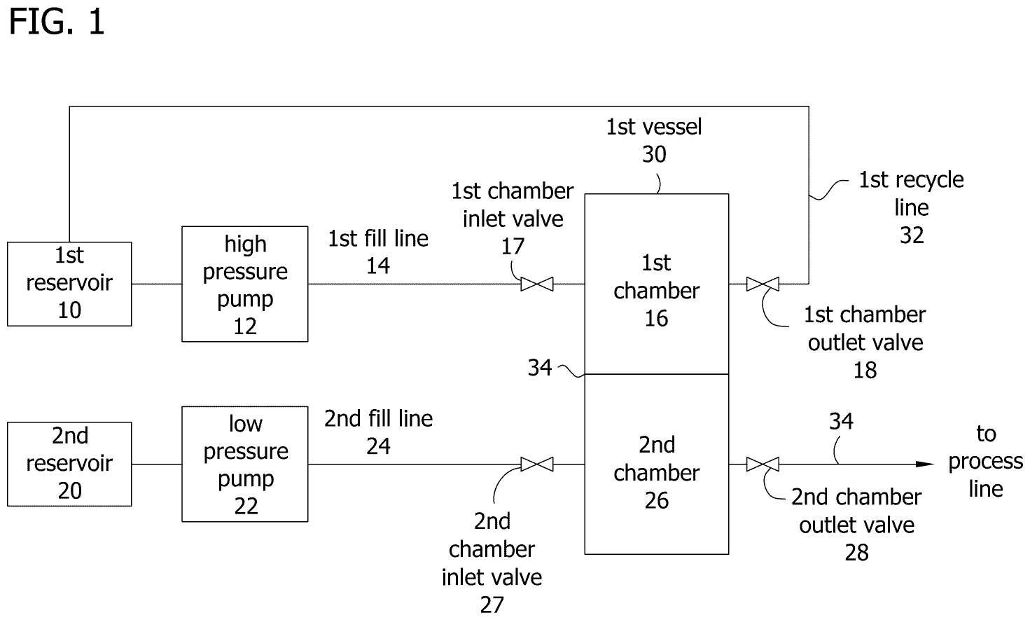

One aspect of the disclosure is directed to an apparatus for pumping a shear-sensitive fluid to an application, as depicted in FIG. 1, the apparatus comprising: a first reservoir 10 for holding a first fluid; a second reservoir 20 for holding a second fluid wherein the second fluid is a shear-sensitive fluid; a first vessel 30 comprising a first chamber 16 and a second chamber 26, a movable partition 34 between the first chamber 16 and the second chamber 26 wherein the first chamber and the second chamber are not in fluid communication with each other; a high pressure pump 12 in fluid communication with the first reservoir 10 and the first chamber 16 through the first fill line 14; a first chamber inlet valve 17, a first chamber outlet valve 18, fill line 14 and recycle line 32 being connected to ports of a three-way valve incorporating inlet valve 17 and outlet valve 18; a low pressure pump 22 in fluid communication with the second reservoir 20 and the second chamber 26 through a second fill line 24 and second chamber inlet valve 27; a second chamber outlet valve 28; and a second exit line 34 in fluid communication with the second chamber 26 and an process line 34 through the second chamber outlet check valve 28; and a switching circuit in electrical communication with an actuator associated with the first chamber inlet valve, the first chamber outlet valve, the second chamber inlet valve, and the second chamber outlet valve.

The first chamber inlet valve and the first chamber outlet valve can be configured to be a 3-way valve that controls the flow of the first fluid into and out of the first chamber.

The second chamber inlet valve and the second chamber outlet valve can also be configured as a 3-way valve that controls the flow of the second fluid into and out of the second chamber.

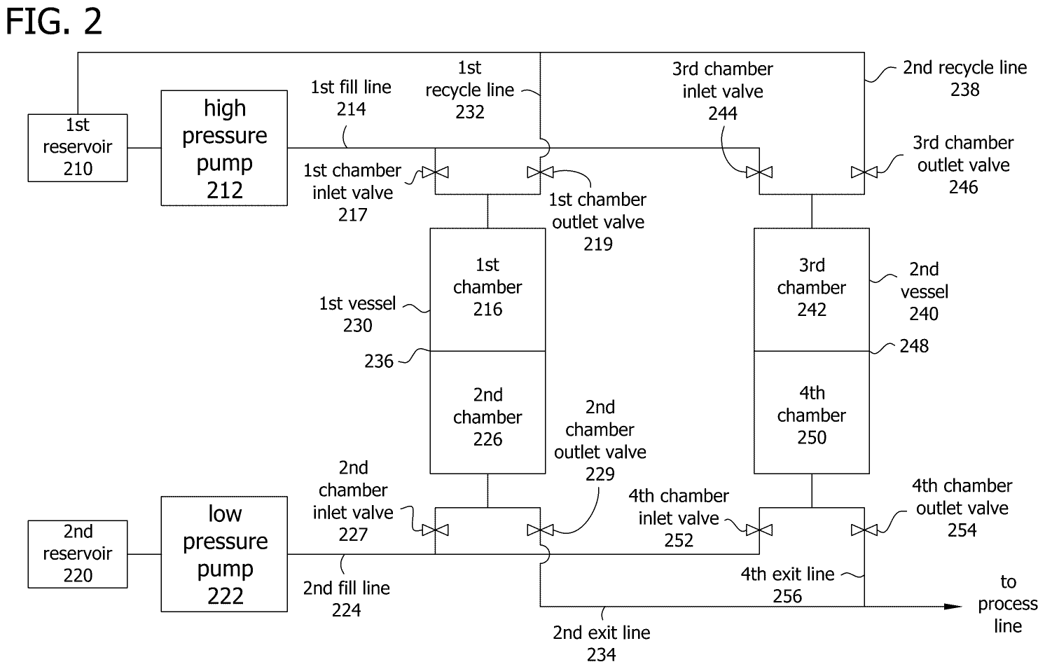

Another aspect of the disclosure is an apparatus for pumping a shear-sensitive fluid to an application, as depicted in FIG. 2, the apparatus comprising: a first reservoir 210 for holding a first fluid; a second reservoir 220 for holding a second fluid wherein the second fluid is a shear-sensitive fluid; a first vessel 230 comprising a first chamber 216 and a second chamber 226, a movable partition 236 between the first chamber 216 and the second chamber 226 wherein the first chamber 216 and the second chamber 226 are not in fluid communication with each other; a second vessel 240 comprising a third chamber 242 and a fourth chamber 250, a movable partition 248 between the third chamber 242 and the fourth chamber 250 wherein the third chamber 242 and the fourth chamber 250 are not in fluid communication with each other; a high pressure pump 212 in fluid communication with the first reservoir 210, the first chamber 216, and the third chamber 242 through a first fill line 214, a first chamber inlet valve 217, and a third chamber inlet valve 244; a low pressure pump 222 in fluid communication with the second reservoir 220, the second chamber 226, and the fourth chamber 250 through a second fill line 224, a second chamber inlet valve 227, a fourth chamber inlet valve 252; a first recycle line 232 in fluid communication with the first chamber 216 and the first fluid reservoir 210 through the first chamber outlet valve 219; a second recycle line 238 in fluid communication with the third chamber 242 and the first fluid reservoir 210 through the third chamber outlet valve 246; a second exit line 234 in fluid communication with the second chamber 226 and a process line through the second chamber outlet valve 229; and a fourth exit line 256 in fluid communication with the fourth chamber 250 and the process line through the fourth chamber outlet valve 254; and a switching circuit in electrical communication with any actuators associated with the inlet and outlet valves of chambers one (217, 219), two (227, 229), three (244, 246) and four (252, 254).

Another aspect of the disclosure is an apparatus for pumping a shear-sensitive fluid to an application, the apparatus comprising: a first reservoir for holding a first fluid; a second reservoir for holding a second fluid wherein the second fluid is a shear-sensitive fluid; a first vessel comprising a first chamber and a second chamber, a movable partition between the first chamber and the second chamber wherein the first chamber and the second chamber are not in fluid communication with each other; a second vessel comprising a third chamber and a fourth chamber, a movable partition between the third chamber and the fourth chamber wherein the third chamber and the fourth chamber are not in fluid communication with each other; a high pressure pump in fluid communication with the first reservoir, the first chamber, and the third chamber through a first fill line, a first 3-way valve, and a second 3-way valve; a low pressure pump in fluid communication with the second reservoir, the second chamber, and the fourth chamber through a second fill line, a second chamber inlet check valve, a fourth chamber inlet check valve; a first recycle line in fluid communication with the first chamber and the first fluid reservoir through the first 3-way valve; a second recycle line in fluid communication with the third chamber and the first fluid reservoir through the second 3-way valve; a second exit line in fluid communication with the second chamber and an umbilical line through the second chamber outlet check valve; and a fourth exit line in fluid communication with the fourth chamber and the process line through the fourth chamber outlet check valve; and a switching circuit in electrical communication with actuators associated with the 3-way valves of chambers one and three.

The apparatus can further comprise a pressure relief valve between the flow line after the high-pressure pump and the first reservoir.

The apparatus can further comprise a filter between the low pressure pump and the second chamber or between the low pressure pump and the fourth chamber.

The apparatus can further comprise a heat exchanger in the second fill line between the low pressure pump and the second chamber or between the low pressure pump and the fourth chamber.

The high-pressure pump can have a maximum working pressure of at least 10,000 pounds per square inch (PSI) and can be equal to or greater than 25,000 pounds per square inch (PSI). The high-pressure pump can have a maximum flow rate of at least 0.5 gallons per minute (GPM). The high-pressure pump can be a positive displacement pump.

The low pressure pump can have a maximum working pressure of equal to or less than 500 PSI, preferably the low pressure pump has a working pressure of about 100 PSI or less. The low pressure pump can also be a positive displacement pump.

The movable partition of the enclosed vessel comprises a bladder, a piston, or a diaphragm. The enclosed vessel can comprise an accumulator. The accumulator can have a volume of about 0.1 gallons to about 50 gallons. The accumulator can have a rating of up to 15,000 psi of pressure.

The transfer accumulators suitable for this apparatus typically have one entry/exit port through the external pressure housing into each chamber of the two-chamber accumulator. To equip each chamber with an inlet and exit valve, it is necessary to connect a “Tee” to the port. One of the three Tee connections would be in liquid communication with an inlet valve. Another one of the Tee connections would be in liquid communication with an exit valve. The third Tee connection would be in liquid communication with the port of an accumulator chamber. The inlet and exit valves may have many forms including, but not limited to, check valves, 2-way ball valves, 3-way ball valves, needle valves, gate valves, butterfly valves, stop valves, pressure relief valves, and poppet valves. A 3-way ball valve incorporates the Tee as part of its internal structure. The valves may be actuated manually, or by air pressure, or by an electric motor or solenoid. A combination of different valves may be useful for different functions within the apparatus.

It is necessary to control when the vessel switches from a pumping mode to a re-fill mode. This would be accomplished by opening and closing from one to four valves. The opening and closing of the valves can be done manually, but more preferably, would be done automatically using pneumatic or electrically actuated valves controlled by a switching circuit.

Several events may be used to trigger the switching of the valves to change from pumping mode to re-fill mode. The simplest event may be a cycle timer reaching the end of a programmed cycle and activating or deactivating an electrical output. The cycle time length would be a function of the first fluid pump rate and the desired fill capacity of the vessel. Another event may be the closing or opening of an electrical contact due to the movement of the movable partition that separates the two chambers. A sensor switch may be positioned within one of the chambers that is activated when the partition touches the sensor at a pre-determined volume level. Another event may be the closing or opening of an electrical contact due to the volume of the first fluid expelled from the vessel during a re-fill operation. The sensor might be activated by the weight of the first fluid or a change in capacitance due to the first fluid reaching a height in a sight tube as it exits the vessel. A combination of these trigger events may be used to facilitate switching between modes of operation.

Additionally, the switching circuit controlling the inlet and outlet valves can be a mechanical switch or be based on a sensor that measures any physical variable, for example, time, pressure, liquid level in the bladder, bladder expansion, mass, volume, weight, capacitance, or combinations thereof. The value that is measured by the sensor can be used to control the switching of the inlet and outlet valves into and out of the bladder.

In particular, a pressure sensor can be used in the particular chamber to provide a measurement where the switching circuit would switch from filling the chamber to evacuating the chamber.

Also, a sensor or switch could be installed within the second and fourth chambers that would activate the switching circuit when the bladder reached a predetermined degree of expansion and activates the switching circuit accordingly.

Additionally, a flow sensor could be used that would measure the mass of the first or second fluid through the system. A PLC would trigger the valve orientation change when a certain amount of fluid had passed by the sensor.

Further, a container could be installed to measure the volume or weight of the first fluid as it left the recycle valve. The first fluid could fill a glass tube as it exited chamber one or three. When the fluid reached a predetermine height, a sensor (float or capacitance) would activate the valve switch and also activate a solenoid valve to drain the fluid from the glass tube back into the first reservoir.

The shear-sensitive fluid can comprise an emulsion polymer. The emulsion polymer can comprise a drag reducing polymer, inversion polymer, or other polymeric compositions that are shear-sensitive.

The umbilical line can lead to a subterranean hydrocarbon reservoir.

The first fluid can comprise water, ethylene glycol, or other non-compressible fluid.

In another aspect, the disclosure is directed to a method of pumping a shear-sensitive fluid to an application using the two-chambered apparatus described elsewhere in this disclosure and in FIG. 1, the method comprising: filling the first reservoir with the first fluid; filling the second reservoir with the second shear-sensitive fluid; pumping the second fluid from the second reservoir through the second fill line into the second chamber using the low pressure pump while having the first chamber outlet valve open and allowing the first fluid through the first recycle line to the first reservoir; then closing the first chamber exit valve when sufficient time has passed, based upon the flowrate of the low pressure pump, such that the fluid level in the first chamber is less than 10% of the total volume of the first vessel and pumping the first fluid from the first reservoir through the first fill line into the first chamber using the high pressure pump while having the second chamber outlet check valve open allowing the shear-sensitive fluid to flow into the umbilical line; opening the first chamber outlet valve when sufficient time has passed, based upon the flowrate of the high pressure pump, such that the fluid level in the first chamber is greater than 50% of the total volume of the first vessel, and allowing the process to repeat.

Further, referring to FIG. 1, the shear-sensitive fluid (e.g., second fluid) is stored in the second reservoir and is passed through the second fill line via the low pressure pump to fill the second chamber of the first vessel. This first vessel is a two-chambered enclosed chamber with a movable partition between the two chambers. The first fluid is stored in the first reservoir and is passed through a first fill line via a high-pressure pump to fill the first chamber of a first vessel. This pushes the movable partition of the vessel to expel the shear-sensitive second fluid from the second chamber through the second outlet valve to the application. Refilling the second chamber with shear-sensitive fluid from the second reservoir also pushes the movable partition of the vessel to expel the first fluid through the first outlet valve and first recycle line back to the first reservoir, where it can be reused to fill the first chamber. The temperature of this process can be managed with a heat exchanger.

In yet another aspect, the disclosure is directed to a method of pumping a shear-sensitive fluid to an application using the four-chambered apparatus described elsewhere in this disclosure and in FIG. 2, the method comprising: filling the first reservoir with the first fluid; filling the second reservoir with the second shear-sensitive fluid; pumping the second fluid from the second reservoir through the second fill line into the second chamber using the low pressure pump while having the first chamber outlet valve open and allowing the first fluid through the first recycle line to the first reservoir; pumping the first fluid from the first reservoir through the first fill line into the third chamber using the high pressure pump while having the fourth chamber outlet valve open allowing the shear-sensitive fluid to flow into the umbilical line; then closing the first chamber outlet valve and opening the third chamber outlet valve when sufficient time has passed, based upon the flowrate of the low pressure pump, such that the fluid level in the first chamber is less than 10% of the total volume of the first vessel and pumping the first fluid from the first reservoir through the first fill line into the first chamber using the high pressure pump while having the second chamber outlet valve open allowing the shear-sensitive fluid to flow into the umbilical line; pumping the second fluid from the second reservoir through the second fill line (the second chamber inlet valve is closed) into the fourth chamber using the low pressure pump while having the third chamber outlet valve open and allowing the first fluid through the second recycle line to the first reservoir; then opening the first chamber outlet valve and closing the third chamber outlet valve after sufficient time has passed, based upon the flowrate of the low pressure pump, such that the fluid level in the third chamber is less than 10% of the total volume of the second vessel and allowing the process to repeat.

Additionally, referring to FIG. 2, the apparatus of FIG. 2 has the same basic setup as FIG. 1 but differs in that it has a second vessel comprising a third and fourth chamber with movable partition integrated into the apparatus. A first chamber 3-way valve can be used to direct the first fluid from the first fill line to the first chamber or from the first chamber to the first recycle line. Check valves can be used to direct shear-sensitive fluid from the low pressure pump and second fill line to the second chamber or to the fourth chamber. A third chamber 3-way valve can be used to direct first fluid either from the first fill line to the third chamber or from the third chamber to the second recycle line back to the first reservoir that stores first fluid. Check valves can be used to directed shear-sensitive fluid from the second chamber through the second exit line or from the fourth chamber through the fourth exit line into the umbilical line to be used in an application.

The extent to which the first fluid fills the first chamber at the beginning and end of the pumping mode can range from 0 to 100% of the internal volume of the vessel. For operational reasons, it is desired to fill the first chamber to less than 100% of capacity, such as 80% of capacity, when the switching circuit closes the first fill line and opens the first recycle line. It is expected that a fill volume of 50 to 80% of capacity during the pumping mode would provide optimum operational efficiency. The volume of the first chamber may be 0% of capacity at the end of the re-fill operation or may be a higher value such as 10% or 20% of capacity. It is expected that a fill volume of 0 to 10% of capacity for the first chamber during the re-fill mode would provide optimum operational efficiency.

The methods can result in the transfer of the pumping pressure to the emulsion in a non-shearing manner.

Another aspect of the disclosure is a method of increasing oil production and/or flow of oil by reducing friction loss due to turbulent flow in subsea produced fluid flowlines, the method comprising: performing one of the methods described elsewhere in the disclosure; wherein the second fluid comprises suspended polymer liquids, such as a drag reducing agent (DRA), a dispersion polymer, a paraffin inhibitor, or a production chemical agent in the form of an emulsion polymer.

The application can be an umbilical application; wherein the drag reducing agent is continuously delivered from topside through an umbilical line to the flowlines.

A switching circuit such as a programmable logic controller (PLC) can actuate the valves to keep a constant flow of shear-sensitive second fluid to the application via the umbilical line by ensuring that the second chamber is being filled with shear-sensitive second fluid while the fourth chamber is being emptied of shear-sensitive second fluid and that the fourth chamber is being filled with shear-sensitive second fluid while the second chamber is being emptied of shear-sensitive second fluid. The temperature of this process can be managed with a heat exchanger.

The PLC can also be integrated with a sensor that measures time, pressure, liquid level in the bladder, bladder expansion, mass, volume, weight, or capacitance. The value that is measured by the sensor can be used to control the switching of the inlet and outlet valves into and out of the bladder. The sensor can be used as described herein above.

For either apparatus, the high pressure pump can be a 12 k psi, 0.5 GPM pneumatic pump (e.g. CheckPoint 8412 pneumatic pump), while the low pressure pump can be a 100 psi, 5 GPM diaphragm pump. An example vessel is a modified 10 k bladder accumulator. Accumulators are also commercially available with a rating up to 15,000 psi of pressure and in sizes from 2.5-50 gallons.

The first fluid can be a non-compressible fluid such as water, ethylene glycol, or other non-compressible fluid.

The shear-sensitive second fluid can be a shear-sensitive suspended polymer liquid.

In particular, the shear-sensitive suspended polymer liquid can be an emulsion polymer.

In particular, the shear-sensitive suspended polymer liquid can be a polyacrylate emulsion polymer, a polymethacrylate emulsion polymer, or a polyolefin suspension.

The application can be pumping a shear sensitive fluid of drag reducing agent (DRA) to an umbilical line such as a subsea manifold.

A sealed NEMA box can be used for the timer and solenoid valves that actuate the valves.

One or more sensors in or on the vessels can be used to determine the fluid volume in each chamber to inform when the valves are actuated.

The valves can be 3-way pneumatic ball valves.

Having described the invention in detail, it will be apparent that modifications and variations are possible without departing from the scope of the invention defined in the appended claims.

### EXAMPLES

The following non-limiting examples are provided to further illustrate the present invention.

### Example 1: Pumping of Sensitive Fluids

The present disclosure describes a pump and a method of pumping emulsion polymers and other sensitive fluids that eliminates the high shear that can be destructive to the fluid (see FIG. 1). The high shear is eliminated by pumping a stable, non-compressible fluid such as water into an enclosed vessel with a movable partition that forces the sensitive fluid out of the vessel and on to the point of application.

The enclosed vessel can be refilled with the sensitive fluid by toggling two 3-way valves to vent the stable fluid to a reservoir at ambient pressure while using mild force to push more sensitive fluid into the vessel and move the partition to expand the volume area for the sensitive fluid. This process can be automated with a cycle timer or sensors and a programmable logic controller (PLC) to alternate between filling with the stable fluid/expelling the sensitive fluid and filling with the sensitive fluid/expelling the stable fluid. A sealed NEMA box can be used for the timer and solenoid valves that actuate the valves. The inlet and outlet valves can be combined as ¼″ 3-way pneumatic ball valves. The stable fluid is recycled via a first recycle line through a 3-way valve while the sensitive fluid is sent via an outlet check valve to the point of application.

### Example 2: Continuous Pumping of Sensitive Fluids

Two enclosed vessels such as bladder accumulators can be used to facilitate continuous pumping the sensitive fluid without pumping it directly through a high-shear pump (see FIG. 2). The high-pressure pump would pump a stable fluid like water into the bladder in the accumulator. The expanding bladder would force the emulsion polymer out of the accumulator and down the umbilical tube to the seafloor. While this is happening, the second accumulator would be refilling with emulsion polymer using a low-shear pump. The water in the bladder would be vented back to a reservoir at ambient pressure. A switching circuit incorporating a cycle timer or programmable logic controller (PLC) would switch back and forth between the two accumulators by actuating 3-way valves to keep a constant flow of emulsion to the application.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

1. An apparatus for pumping a shear-sensitive fluid to an application comprising:
a first reservoir for holding a first fluid;
a second reservoir for holding a second fluid wherein the second fluid is a shear-sensitive fluid;
a first vessel comprising a first chamber and a second chamber, a movable partition between the first chamber and the second chamber wherein the first chamber and the second chamber are not in fluid communication with each other;
a high pressure pump in fluid communication with the first reservoir and the first chamber through a first fill line and a first chamber inlet valve;
a low pressure pump in fluid communication with the second reservoir and the second chamber through a second fill line and a second chamber inlet valve;
a first recycle line in fluid communication with the first chamber and the first fluid reservoir through a first chamber outlet valve; and
a second exit line in fluid communication with the second chamber through a second chamber outlet valve; and
a switching circuit actuated by a sensor or PLC capable of controlling the first chamber inlet valve, the first chamber outlet valve, the second chamber inlet valve, and the second chamber outlet valve.

2. The apparatus of claim 1, wherein the second exit line is in fluid communication with an umbilical line.

3. An apparatus for pumping a shear-sensitive fluid to an application comprising:
a first reservoir for holding a first fluid;
a second reservoir for holding a second fluid wherein the second fluid is a shear-sensitive fluid;
a first vessel comprising a first chamber and a second chamber, a movable partition between the first chamber and the second chamber wherein the first chamber and the second chamber are not in fluid communication with each other;
a second vessel comprising a third chamber and a fourth chamber, a movable partition between the third chamber and the fourth chamber wherein the third chamber and the fourth chamber are not in fluid communication with each other;
a high-pressure pump in fluid communication with the first reservoir, the first chamber, and the third chamber through a first fill line, a first chamber inlet valve, and a third chamber inlet valve;
a low pressure pump in fluid communication with the second reservoir, the second chamber, and the fourth chamber through a second fill line, a second chamber inlet valve, and a fourth chamber inlet valve;
a first recycle line in fluid communication with the first chamber and the first fluid reservoir through the first chamber outlet valve;
a second recycle line in fluid communication with the third chamber and the first fluid reservoir through the third chamber outlet valve;
a second exit line in fluid communication with the second chamber through the second chamber outlet valve; and
a fourth exit line in fluid communication with the fourth chamber through the fourth chamber outlet valve; and
a switching circuit actuated by a sensor or PLC capable of controlling the first chamber inlet valve, the first chamber outlet valve, the second chamber inlet valve, the second chamber outlet valve, the third chamber inlet valve, the third chamber outlet valve, the fourth chamber inlet valve, and the fourth chamber outlet valve.

4. The apparatus of claim 3, wherein the second exit line and the fourth exit line are in fluid communication with an umbilical line.

5. The apparatus of claim 3, wherein the second chamber inlet valve, second chamber outlet valve, the fourth chamber inlet valve, and the fourth chamber outlet valve are check valves oriented to allow the flow of liquid from the second fill line to the process line.

6. The apparatus of claim 3, wherein the inlet and outlet valves of the first chamber, the second chamber, the third chamber, or the fourth chamber are combined into single three-way ball valves that encompass both inlet and outlet functions.

7. The apparatus of claim 1, wherein the switching circuit controlling the inlet and outlet valves is a mechanical switch or includes a sensor that measures time, pressure, liquid level in the bladder, bladder expansion, mass, volume, weight, or capacitance.

8. The apparatus of claim 1, wherein the switching circuit is a cycle timer.

9. The apparatus of claim 1, wherein the apparatus further comprises a pressure relief valve in the first fill line between the high-pressure pump and the first reservoir and a pressure relief valve in the second fill line between the low pressure pump and the second reservoir.

10. (canceled)

11. The apparatus of claim 3, wherein the apparatus further comprises a spring-loaded check valve in the second exit line after the second chamber outlet valve and the fourth chamber outlet valve.

12. The apparatus of claim 1, wherein the apparatus further comprises a filter in the second fill line after the low pressure pump.

13. The apparatus of claim 12, wherein the apparatus further comprises a heat exchanger in the second fill line between the second reservoir and the second or fourth chamber.

14. The apparatus of claim 6, wherein one or more of the inlet valves or outlet valves of the first, second, third, and fourth chambers are actuated by air pressure controlled by electrical solenoids in turn controlled by the switching circuit or by an electric motor or solenoid controlled by the switching circuit.

15. (canceled)

16. The apparatus of claim 1, wherein the high-pressure pump has a maximum working pressure of at least 10,000 pounds per square inch (PSI) and up to or greater than 25,000 PSI.

17. The apparatus of claim 1, wherein the high-pressure pump is a positive displacement pump and the low pressure pump is a positive displacement pump.

18. (canceled)

19. The apparatus of claim 1, wherein the movable partition of the enclosed vessel comprises a bladder, a piston, or a diaphragm.

20. The apparatus of claim 19, wherein the first or second vessel comprises an accumulator.

21. The apparatus of claim 20, wherein the accumulator has a volume of about 0.1 gallons to about 50 gallons.

22.-27. (canceled)

28. A method of pumping a shear-sensitive fluid to an application using the apparatus of claim 1, the method comprising:
filling the first reservoir with the first fluid;
filling the second reservoir with the second fluid;
pumping the second fluid from the second reservoir through the second fill line into the second chamber using the low pressure pump while having the first chamber outlet valve open;
closing the first chamber outlet valve based on a sensor value, based upon the flowrate of the low pressure pump, such that the fluid level in the first chamber is less than 10% of the total volume of the first vessel; pumping the first fluid from the first reservoir through the first fill line into the first chamber using the high-pressure pump; forcing the shear-sensitive fluid to flow into the process line through the second chamber outlet valve;
closing the first chamber inlet valve and opening the first chamber outlet valve based on a sensor value, based upon the flowrate of the high pressure pump, such that the fluid level in the first chamber is greater than 50% of the total volume of the first vessel; and allowing the first fluid to exit through the first recycle line back to the first reservoir.

29.-31. (canceled)

32. A method of increasing oil production and/or flow of oil by reducing friction loss due to turbulent flow in subsea produced fluid flowlines, the method comprising:
performing the method of claim 28;
wherein the second fluid comprises a drag reducing agent and the application is an umbilical application,
wherein the drag reducing agent is continuously delivered from topside through umbilical to the flowlines.
